(19) United States
(12) Patent Application Publication
(10) Pub. No.: US 2020/0004267 A1
(43) Pub. Date: Jan. 2, 2020

(54) Vehicle-following Deceleration Control Method and System

(71) Applicant: Guangzhou Automobile Group Co., Ltd., Guangzhou, Guangdong (CN)

(72) Inventors: Liang HUANG, Guangzhou, Guangdong (CN); Peiyi ZHOU, Guangzhou, Guangdong (CN); Fen ZHANG, Guangzhou, Guangdong (CN); Xianzhao XU, Guangzhou, Guangdong (CN); Wei XU, Guangzhou, Guangdong (CN)

(21) Appl. No.: 16/307,492

(22) PCT Filed: Mar. 9, 2018
(86) PCT No.: PCT/CN2018/078558

§ 371 Date: Dec. 6, 2018

(30) Foreign Application Priority Data
Mar. 22, 2017 (CN) 201710173919.4

(51) Int. Cl. G05D 1/02

(52) U.S. Cl. CPC G05D 1/0276; G05D 1/0223

(57) ABSTRACT

Related are vehicle-following deceleration control method and system. The method includes: acquiring current deceleration of front vehicle and current inter-vehicle time distance between current vehicle and front vehicle; when monitoring that brake lamp of front vehicle lights, performing increase correction on absolute value of current deceleration of front vehicle to obtain deceleration corrected value, and or performing increase correction on preset inter-vehicle time distance threshold of ACC system of current vehicle; and sending a deceleration request by the ACC system of the current vehicle, in a case where an absolute value of the deceleration corrected value is greater than or equal to an absolute value of a preset deceleration threshold of the ACC system of the current vehicle, or the current inter-vehicle time distance between the current vehicle and the front vehicle is smaller than or equal to the inter-vehicle time distance threshold corrected value.

### TECHNICAL FIELD

The present disclosure relates to the technical field of vehicle safety control, and more particularly, to a vehicle-following deceleration control method and a vehicle-following deceleration control system.

### BACKGROUND

An Adaptive Cruise Control (abbreviated as ACC) system of a vehicle is an intelligent automatic control system. It refers to that when the vehicle recognizes via a millimeter wave radar and confirms that a front vehicle has a deceleration and an inter-vehicle time distance between the vehicle and the front vehicle is smaller than a set value in a driving process, the ACC system will send a deceleration request and may coordinate with an anti-lock brake system and an engine control system to brake wheels appropriately, reduce an output power of an engine and enable the vehicle to keep a safe distance all the time with the front vehicle.

A deceleration control of the ACC system generally refers to follow the deceleration of the front vehicle. In general, when a driver needs to decelerate, an accelerator is released first and then a brake pedal is stamped. However, a brake force in an initial stamping stage is very small, the deceleration of the front vehicle is also relatively small and an ACC system of a rear vehicle is difficult to make a response to the deceleration of the front vehicle timely. As a result, a deceleration of the rear vehicle in a following deceleration later stage is fierce and the stability of the rear vehicle in the following deceleration process is affected.

### SUMMARY

In view of this, the embodiments of the present disclosure provide a vehicle-following deceleration control method and system, which can solve the problem that adaptive cruise deceleration of a rear vehicle cannot be responded timely when a deceleration of a front vehicle is relatively small.

One aspect of the present disclosure provides a vehicle-following deceleration control method, which may include the following steps.

A current deceleration of a front vehicle and an current inter-vehicle time distance between a current vehicle and the front vehicle are acquired, and whether a brake lamp of the front vehicle lights or not is monitored.

When it is monitored that the brake lamp of the front vehicle lights, increase correction is performed on an absolute value of the current deceleration of the front vehicle to obtain a deceleration corrected value, and/or an increase correction is performed on a preset inter-vehicle time distance threshold of an ACC system of the current vehicle to obtain an inter-vehicle time distance threshold corrected value.

A deceleration request is sent by the ACC system of the current vehicle, in a case where an absolute value of the deceleration corrected value is greater than or equal to an absolute value of a preset deceleration threshold of the ACC system of the current vehicle, or the current inter-vehicle time distance between the current vehicle and the front vehicle is smaller than or equal to the inter-vehicle time distance threshold corrected value.

Another aspect of the present disclosure provides a vehicle-following deceleration control system, which may include a monitoring module, a correction module and a deceleration response module.

The monitoring module is configured to acquire a current deceleration of a front vehicle and an current inter-vehicle time distance between a current vehicle and the front vehicle, and monitor whether a brake lamp of the front vehicle lights or not.

The correction module is configured to when monitoring that the brake lamp of the front vehicle lights, perform increase correction on an absolute value of the current deceleration of the front vehicle to obtain a deceleration corrected value, and/or perform an increase correction on a preset inter-vehicle time distance threshold of an ACC system of the current vehicle to obtain an inter-vehicle time distance threshold corrected value.

The deceleration response module is configured to send a deceleration request via the ACC system of the current vehicle, in a case where an absolute value of the deceleration corrected value is greater than or equal to an absolute value of a preset deceleration threshold of the ACC system of the current vehicle, or in a case where the current inter-vehicle time distance between the current vehicle and the front vehicle is smaller than or equal to the inter-vehicle time distance threshold corrected value.

Based on the vehicle-following deceleration control method and system provided by the above embodiments, whether the brake lamp of the front vehicle lights or not is monitored; when it is monitored that the brake lamp of the front vehicle lights, the increase correction is performed on the absolute value of the current deceleration of the front vehicle to obtain the deceleration corrected value, and/or the increase correction is performed on the preset inter-vehicle time distance threshold of the ACC system of the current vehicle to obtain the inter-vehicle time distance threshold corrected value; and in the case where the absolute value of the deceleration corrected value is greater than or equal to the absolute value of the preset deceleration threshold of the ACC system of the current vehicle, or the current inter-vehicle time distance between the current vehicle and the front vehicle is smaller than or equal to the inter-vehicle time distance threshold corrected value, the deceleration request is sent by the ACC system of the current vehicle. According to the solutions of the present disclosure, even though the front vehicle only has a relatively small deceleration, the ACC system of the rear vehicle can also make a response timely, which is beneficial to improving the stability of the rear vehicle in a following deceleration process.

### BRIEF DESCRIPTION OF THE DRAWINGS

FIG. 1 is a schematic flowchart of a vehicle-following deceleration control method in an embodiment.

FIG. 2 is a schematic flowchart of a vehicle-following deceleration control method in another embodiment.

FIG. 3 is a schematic flowchart of a vehicle-following deceleration control method in another embodiment.

FIG. 4 is a schematic structural diagram of a vehicle-following deceleration control system in an embodiment.

### DETAILED DESCRIPTION OF THE EMBODIMENTS

For making the purpose, technical solutions and advantages of the present disclosure clearer, the present disclosure will further be described below in combination with the drawings and embodiments in detail. It should be understood that the specific embodiments described here are adopted not to limit the present disclosure but only to explain the present disclosure.

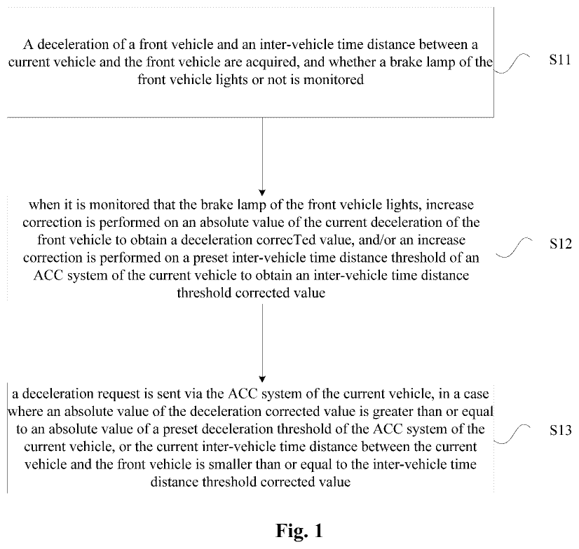

FIG. 1 is a schematic flowchart of a vehicle-following deceleration control method in an embodiment. As shown in FIG. 1, the vehicle-following deceleration control method in this embodiment may include the following steps:

At S11, a current deceleration of a front vehicle and a current inter-vehicle time distance between a current vehicle and the front vehicle are acquired, and whether a brake lamp of the front vehicle lights or not is monitored.

In one embodiment, during a driving process, it may be appropriate to collect an image of the front vehicle in a lane which the current vehicle is in, in real time via a camera, mounted on a vehicle body in advance, recognize an area where the brake lamp of the front vehicle is located from the image and judge whether the brake lamp of the front vehicle lights or not according to an image of the area where the brake lamp of the front vehicle is located. In at least one alternative embodiment, whether a left brake lamp, a right brake lamp and/or a high brake lamp of the front vehicle light or not may be monitored; that is, when it is recognized that the left brake lamp, the right brake lamp and/or the high brake lamp of the front vehicle in the lane lights, information of the brake lamp of the front vehicle lights is sent to an ACC system of the current vehicle.

In at least one alternative embodiment, the current deceleration of the front vehicle and the current inter-vehicle time distance between the current vehicle and the front vehicle may be obtained by adopting a sensor (such as a radar) preliminarily mounted on the current vehicle and are transferred to the ACC system of the current vehicle. Herein, the inter-vehicle time distance refers to an average distance between a head of a rear vehicle and a tail of the front vehicle in a unit time.

At S12, when it is monitored that the brake lamp of the front vehicle lights, increase correction is performed on an absolute value of the current deceleration of the front vehicle to obtain a deceleration corrected value, and/or an increase correction is performed on a preset inter-vehicle time distance threshold of an ACC system of the current vehicle to obtain an inter-vehicle time distance threshold corrected value.

When it is monitored that the brake lamp of the front vehicle lights, it is indicated that the front vehicle has an abnormal condition, including that the front vehicle starts to decelerate or changes the lane or other conditions. At this moment, a driver of the rear vehicle needs to take a countermeasure timely, for example, decelerate timely and increase the safety distance. However, whether to start a deceleration response of the ACC system or not is determined by a deceleration value of the front vehicle monitored based on the radar. When the deceleration of the front vehicle is relatively small, the deviation ratio of the deceleration of the front vehicle monitored by the radar is relatively high or even it is difficult to detect that the front vehicle has the deceleration. At this moment, the deceleration, received by the ACC system, of the front vehicle does not reach to the set deceleration threshold and the ACC system cannot be triggered to execute the deceleration response, so that a deceleration action of the rear vehicle is delayed relative to the front vehicle and the stability of the vehicle-following deceleration is affected.

At S13, a deceleration request is sent by the ACC system of the current vehicle, in a case where an absolute value of the deceleration corrected value is greater than or equal to an absolute value of a preset deceleration threshold of the ACC system of the current vehicle, or the current inter-vehicle time distance between the current vehicle and the front vehicle is smaller than or equal to the inter-vehicle time distance threshold corrected value.

In one embodiment, when a trigger condition that the ACC system of the current vehicle executes the deceleration response (that is, the absolute value of the deceleration corrected value is greater than or equal to the absolute value of the preset deceleration threshold of the ACC system of the current vehicle for triggering a brake request, or the current inter-vehicle time distance between the current vehicle and the front vehicle is smaller than or equal to the inter-vehicle time distance threshold corrected value), the ACC system of the current vehicle will send a corresponding deceleration request to a brake execution mechanism (such as an anti-lock brake system and an engine control system) to perform the deceleration control on the current vehicle timely.

Through the above embodiment, when it is monitored that the brake lamp of the front vehicle lights, the absolute value of the currently obtained deceleration of the front vehicle may be magnified immediately, so that the magnified deceleration corrected value of the front vehicle can trigger the ACC system of the current vehicle to execute the deceleration response on one hand. On the other hand, the preset inter-vehicle time distance threshold of the ACC system of the current vehicle may further be magnified immediately; that is, by increasing the safety distance between the current vehicle and the front vehicle, the ACC system of the current vehicle is triggered to execute the deceleration response timely.

In a preferred embodiment, a manner for performing the increase correction on the absolute value of the current deceleration of the front vehicle in the step S12 may be as follows: the absolute value of the current deceleration of the front vehicle is replaced as a first set value, the first set value being greater than the absolute value of the current deceleration of the front vehicle; correspondingly, the first set value needs to be set in advance; or the absolute value of the current deceleration of the front vehicle is magnified by a first set times, for example, the absolute value of the current deceleration of the front vehicle is magnified by 0.5 times (namely, magnifying to 1.5 times), 1 times (namely, magnifying to 2 times) or other times; or the absolute value of the current deceleration of the front vehicle may be added with a set fixed value as long as it can be magnified to trigger the ACC system of the current vehicle to execute the deceleration response.

Correspondingly, a manner for performing the increase correction on the preset inter-vehicle time distance threshold of the ACC system of the current vehicle in the step S12 may be as follows: the preset inter-vehicle time distance threshold of the ACC system of the current vehicle is replaced as a second set value, the second set value being greater than the preset inter-vehicle time distance threshold; or the preset inter-vehicle time distance threshold of the ACC system of the current vehicle is magnified by a second set times; or the preset inter-vehicle time distance threshold of the ACC system of the current vehicle is added with a set value as long as it can be magnified to be greater than the current inter-vehicle time distance, between the current vehicle and the front vehicle so that the ACC system of the current vehicle can be timely triggered to execute the deceleration response.

Based on the vehicle-following deceleration control method provided by the above embodiment, whether the brake lamp of the front vehicle lights or not is monitored; when it is monitored that the brake lamp of the front vehicle lights, the increase correction is performed on the absolute value of the current deceleration of the front vehicle to obtain the deceleration corrected value, and/or the increase correction is performed on the preset, inter-vehicle time distance threshold of the ACC system of the current vehicle to obtain the inter-vehicle time distance threshold corrected value; and in the case where the absolute value of the deceleration corrected value is greater than or equal to the absolute value of the preset deceleration threshold of the ACC system of the current vehicle, or the current inter-vehicle time distance between the current vehicle and the front vehicle is smaller than or equal to the inter-vehicle time distance threshold corrected value, the deceleration request is sent by the ACC system of the current vehicle. According to the solutions of the present disclosure, even though the front vehicle only has a relatively small deceleration, the ACC system of the rear vehicle can also make a response timely, which is beneficial to improving the stability of the rear vehicle in a following deceleration process.

In combination with the vehicle-following deceleration method of the above embodiment and by taking two ways for respectively, correcting the deceleration of the front vehicle and correcting the inter-vehicle time distance threshold as examples, the vehicle-following deceleration method of the present disclosure will be illustrated below.

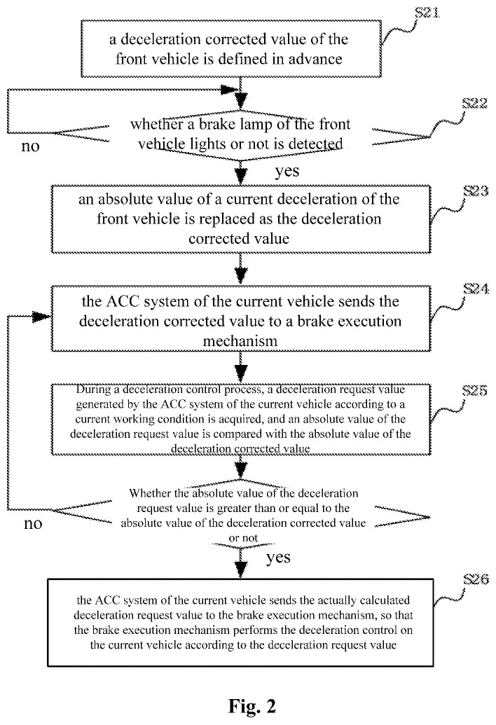

Referring to FIG. 2, a process for implementing vehicle-following automatic deceleration control by correcting a deceleration of a front vehicle is as follows.

At S21, a deceleration corrected value of the front vehicle is defined in advance, where an absolute value of the corrected value should not be too small and should be greater than an absolute value of a deceleration, detected by a millimeter-wave radar, of the front vehicle.

At S22, whether a brake lamp of the front vehicle lights or not is detected. When the detecting result is yes, a next step is executed; or otherwise, this step is executed continuously.

In one embodiment, the deceleration of the front vehicle and the inter-vehicle time distance between the current vehicle and the front vehicle are further detected in real time. For example, the deceleration of the front vehicle and the inter-vehicle time distance between the current vehicle and the front vehicle may be detected by a millimeter-wave radar sensor and the detected information is transferred to an ACC controller.

In at least one alternative embodiment, it may be appropriate to extract a front field-of-view image via a camera, extract an interested area (namely, an image area where the front vehicle in a lane which the current vehicle is in is located) and perform mode recognition on the interested area. An effective mode is that the left brake lamp, the right brake lamp and the high brake lamp light. When the camera recognizes that the brake lamp of the front vehicle in the lane lights, the lighting information will be sent to the ACC controller.

At S23, an absolute value of a current deceleration of the front vehicle is replaced as the deceleration corrected value set in the step S21. An ACC system stores the deceleration corrected value to take as the current deceleration of the front vehicle.

In this embodiment, the preset deceleration corrected value should further be greater than a preset deceleration threshold of the ACC system of the current vehicle for triggering the deceleration control. Therefore, the ACC system is triggered to enter a deceleration response when taking the deceleration corrected value as the current deceleration of the front vehicle.

At S24, the ACC system of the current vehicle sends the deceleration corrected value to a brake execution mechanism, so that the brake execution mechanism performs the deceleration control on the current vehicle according to the deceleration corrected value.

At S25, during a deceleration control process, an actual deceleration request value, calculated according to a current working condition, of the ACC system of the current vehicle is acquired according to a set time period, and whether an absolute value of the deceleration request value is greater than or equal to the absolute value of the deceleration corrected value or not is detected. When the detecting result is yes, a step S26 is executed; or otherwise, the step 24 is executed.

At S26, the ACC system of the current vehicle sends the actually calculated deceleration request value to the brake execution mechanism, so that the brake execution mechanism performs the deceleration control on the current vehicle according to the deceleration request value.

Through the steps S23-326, it may be assured that when the brake lamp of the front vehicle lights, the ACC system can send the deceleration request to a brake system. When the original deceleration request value of the ACC system is very small, the ACC system may send a relatively large deceleration corrected value to the brake system, so that the brake system can brake timely and the delayed following deceleration process is not excessively fierce. Moreover, during a deceleration process, in a case where the actually calculated deceleration request value of the ACC system is smaller than the deceleration corrected value of the front vehicle, the deceleration corrected value of the front vehicle is executed continuously. When the actually calculated deceleration request value of the ACC system is greater than or equal to the deceleration corrected value of the front vehicle, the actually calculated deceleration request value is taken as the deceleration request of the ACC system to send to the brake system. In this way, the smooth transition of the deceleration request from the deceleration corrected value of the front vehicle to the actually calculated deceleration request value of the ACC system is guaranteed and no discomfort of the deceleration is caused.

It may be understood that, after the step S22, in a case where no information on the brake lamp of the front vehicle lights is monitored, the ACC system of the current vehicle makes a brake response according to a normal following cruise mode. For example, when it is detected that an absolute value of the actual deceleration of the front vehicle is greater than or equal to the absolute value of the preset deceleration threshold, the ACC system of the current vehicle sends a brake request instruction to the brake execution mechanism to control the current vehicle to decelerate according to the actual deceleration of the front vehicle, thus guaranteeing that the inter-vehicle time distance between the current vehicle and the front vehicle is within a safety distance range. Or when it is detected that the inter-vehicle time distance between the current vehicle and the front vehicle is smaller than or equal to the preset inter-vehicle time distance threshold, the ACC system of the current vehicle sends the brake request instruction to the brake execution mechanism to control the current vehicle to decelerate according to the preset inter-vehicle time distance, thus guaranteeing, that the inter-vehicle time distance between the current vehicle and the front vehicle is within the safety distance range.

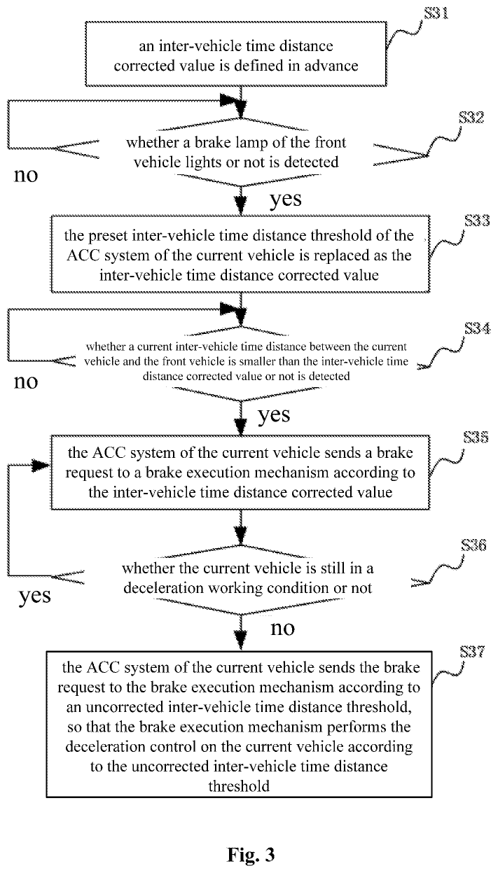

Referring to FIG. 3, a process for implementing vehicle-following automatic deceleration control by correcting a preset inter-vehicle time distance threshold of the ACC system of the current vehicle is as follows.

At S31, an inter-vehicle time distance corrected value is defined in advance. In at least one alternative embodiment, the corrected value may refer to add a fixed value on the basis of an inter-vehicle time distance threshold set by a driver for an ACC system of a current vehicle at present.

At S32, whether a brake lamp of the front vehicle lights or not is detected. When the detecting result is yes, a next step is executed; or otherwise, this step is executed continuously.

In one embodiment, the deceleration of the front vehicle and the inter-vehicle time distance between the current vehicle and the front vehicle are further detected in real time. For example, the deceleration of the front vehicle and the inter-vehicle time distance between the current vehicle and the front vehicle may be detected by a millimeter-wave radar sensor and the detected information is transferred to an ACC controller.

In at least one alternative embodiment, it may be appropriate to extract a front field-of-view image via a camera, extract an interested area (namely, an image area where the front vehicle in a lane which the current vehicle is in, is located) and perform mode recognition on the interested area. An effective modes include that the left brake lamp, the right brake lamp and the high brake lamp light. When the camera recognizes that the brake lamp of the front vehicle in the lane lights, the lighting information will be sent to the ACC controller.

At S33, the preset inter-vehicle time distance threshold of the ACC system of the current vehicle is replaced as the inter-vehicle time distance corrected value set in the step S31. The ACC system stores the inter-vehicle time distance corrected value to take as a current safety cruise distance.

At S34, whether a current inter-vehicle time distance between the current vehicle and the front vehicle is smaller than the inter-vehicle time distance corrected value or not is detected; when the detecting result is yes, a next step is executed; or otherwise, the current step is executed.

At S35, the ACC system of the current vehicle sends a brake request to a brake execution mechanism according to the inter-vehicle time distance corrected value, so that the brake execution mechanism performs the deceleration control on the current vehicle according to the inter-vehicle time distance corrected value.

At S36, during a deceleration control process, whether the current vehicle is still in a deceleration working condition or not is detected according to a set time period, the deceleration working condition being that the brake lamp of the front vehicle lights and a deceleration request value generated by the ACC system of the current vehicle under the current working condition according to an uncorrected deceleration of the front vehicle is smaller than 0; in a case where the current vehicle is still in the deceleration working condition, the step S35 is executed; or otherwise, a step S37 is executed.

At S37, the ACC system of the current vehicle sends the brake request to the brake execution mechanism according to an uncorrected inter-vehicle time distance threshold, so that the brake execution mechanism performs the deceleration control on the current vehicle according to the uncorrected inter-vehicle time distance threshold.

When the deceleration working condition is ended, the ACC system of the current vehicle is restored to an original state and the inter-vehicle time distance threshold is also restored to a state before correction; and the vehicle-following cruise control is performed according to the original state so as to prevent a vehicle-following distance from being excessively large.

It may be understood that, after the step S32, in a case where no information on the brake lamp of the front vehicle lights is monitored, the ACC system of the current vehicle makes a brake response according to a normal vehicle-following cruise mode. For example, when it is detected that an absolute value of the actual deceleration of the front vehicle is greater than or equal to the absolute value of the preset deceleration threshold, the ACC system of the current vehicle sends a brake request instruction to the brake execution mechanism to control the current vehicle to decelerate according to the actual deceleration of the front vehicle, thus guaranteeing that the inter-vehicle time distance between the current vehicle and the front vehicle is within a safety distance range. Or when it is detected that the inter-vehicle time distance between the current vehicle and the front vehicle is smaller than or equal to the preset inter-vehicle time distance threshold, the ACC system of the current vehicle sends the brake request instruction to the brake execution mechanism to control the current vehicle to decelerate according to the preset inter-vehicle time distance, thus guaranteeing that the inter-vehicle time distance between the current vehicle and the front vehicle is within the safety distance range.

It should be noted that, the method embodiments are expressed as combinations of a series of actions for the purpose of simple description, but those skilled in the art should learn that the embodiments of the present disclosure are not limited by the described action sequence, because some steps may adopt other sequence or be simultaneously performed according to the present disclosure. In addition, the above embodiments may further be combined freely to obtain other embodiments.

Based on a concept same as the vehicle-following deceleration control method in the above embodiment, the present disclosure further provides a vehicle-following deceleration control system. The system may be configured to execute the vehicle-following deceleration control method. In order to describe conveniently, in the structural schematic diagram of the embodiment of the vehicle-following deceleration control system, only portions relevant to this embodiment of the present disclosure are shown. It may be understood by those skilled in the art that the shown structures are not formed into a limit to the system and may include more or fewer components shown in the figure, or are combined with some components, or have different component arrangements,

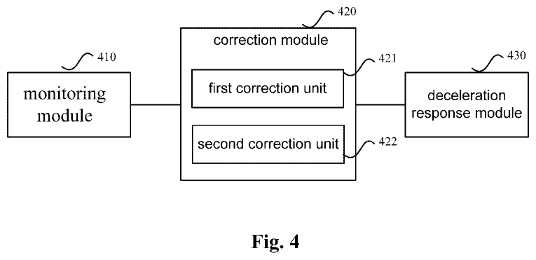

FIG. 4 is a schematic structural diagram of a vehicle-following deceleration control system in an embodiment. As shown in FIG. 4, the vehicle-following deceleration control system in this embodiment may include a monitoring module 410, a correction module 420 and a deceleration response module 430. Each of the above modules will be described below in detail.

The monitoring module 410 is configured to acquire a current deceleration of a front vehicle and an current inter-vehicle time distance between a current vehicle and the front vehicle, and monitor whether a brake lamp of the front vehicle lights or not.

In one embodiment, the monitoring module 410 may include a vehicle lamp monitoring unit, configured to collect an image of the front vehicle in a lane which the current vehicle is in, recognize an area where the brake lamp of the front vehicle is located from the image, and judge whether the brake lamp of the front vehicle lights or not according to an image of the area where the brake lamp of the front vehicle is located.

The correction module 420 is configured to, when it is monitored that the brake lamp of the front vehicle lights, perform increase correction on an absolute value of the current deceleration of the front vehicle to obtain a deceleration corrected value, and/or perform an increase correction on a preset inter-vehicle time distance threshold of an ACC system of the current vehicle to obtain an inter-vehicle time distance threshold corrected value.

In one embodiment, the correction module 420 may include a first correction unit 421, configured to replace the absolute value of the current deceleration of the front vehicle as a first set value, the first set value being greater than the absolute value of the current deceleration of the front vehicle, or magnify the absolute value of the current deceleration of the front vehicle by a first set times; and/or a second correction unit 422, configured to replace the preset inter-vehicle time distance threshold of the ACC system of the current vehicle as a second set value, the second set value being greater than the preset inter-vehicle time distance threshold, or magnify the preset inter-vehicle time distance threshold of the ACC system of the current vehicle by a second set times.

The deceleration response module 430 is configured to send a deceleration request via the ACC system of the current vehicle, in a case where an absolute value of the deceleration corrected value is greater than or equal to an absolute value of a preset deceleration threshold of the ACC system of the current vehicle, or in a case where the current inter-vehicle time distance between the current vehicle and the front vehicle is smaller than or equal to the inter-vehicle time distance threshold corrected value.

In one embodiment, the deceleration response module 430 may include a first deceleration response unit.

The first deceleration response unit is configured to send the deceleration corrected value to a brake execution mechanism via the ACC system of the current vehicle, in a case where the absolute value of the deceleration corrected value is greater than or equal to the absolute value of the preset deceleration threshold of the ACC system of the current vehicle for triggering the brake request, so that the brake execution mechanism performs the deceleration control on the current vehicle according the deceleration corrected value.

Further, the deceleration response module 430 may further include a comparison unit and a first switching unit.

The comparison unit is configured to acquire a deceleration request value, generated by the ACC system of the current vehicle according to a current working condition, according to a set time period, and compare an absolute value of the deceleration request value with the absolute value of the deceleration corrected value, wherein the deceleration request value is a deceleration generated by the ACC system of the current vehicle under the current working condition according to an uncorrected deceleration of the front vehicle.

The first switching unit is configured to notify the first deceleration response unit of continuously sending the deceleration corrected value to the brake execution mechanism, in a case where the absolute value of the deceleration request value is smaller than the absolute value of the deceleration corrected value, or otherwise, notify the first deceleration response unit of sending the deceleration request value to the brake execution mechanism via the ACC system of the current vehicle, so that the brake execution mechanism performs the deceleration control on the current vehicle according to the deceleration request value.

In one embodiment, the deceleration response module 430 may include a second deceleration response unit.

The second deceleration response unit is configured to send a brake request to the brake execution mechanism via the ACC system of the current vehicle according to the inter-vehicle time distance threshold corrected value, in a case where the current inter-vehicle time distance between the current vehicle and the front vehicle is smaller than or equal to the inter-vehicle time distance threshold corrected value, so that the brake execution unit performs the deceleration control on the current vehicle according to the inter-vehicle time distance threshold corrected value.

Further, the deceleration response module 430 may further include a working condition detection unit and a second switching unit.

The working condition detection unit is configured to periodically judge whether the current vehicle is in a deceleration working condition or not at present, after the brake request is sent to the brake execution mechanism via the ACC system of the current vehicle according to the inter-vehicle time distance threshold corrected value, wherein the deceleration working condition refers to that the brake lamp of the front vehicle lights and a deceleration request value generated by the ACC system of the current vehicle under the current working condition according to an uncorrected deceleration of the front vehicle is smaller than 0.

The second switching unit is configured to notify the second deceleration response unit of continuously sending the brake request to the brake execution mechanism according to the inter-vehicle time distance threshold corrected value, in a case where the current vehicle is still in the deceleration working condition, or otherwise, notify the second deceleration response unit of sending the brake request to the brake execution mechanism via the ACC system of the current vehicle according to an uncorrected inter-vehicle time distance threshold, so that the brake execution mechanism performs the deceleration control on the current vehicle according to the uncorrected inter-vehicle time distance threshold.

It is to be noted that, in the implementation manner of the vehicle-following deceleration control system in the above embodiment, since contents such as information interaction and an execution process between modules are based on the same concept as the above method embodiment of the present disclosure, the technical effect thereto is the same as the above method embodiment of the present disclosure, and the specific contents may be referred to the description in the above method embodiment of the present disclosure and will not be repeated here.

In addition, in the implementation manner of the vehicle-following deceleration control system in the above embodiment, the logical division of each functional module is merely for description and may be considered as required in an actual application, for example, with a view to a configuration requirement or software implementation of corresponding hardware. The above functional distribution is completed by different functional modules, that is, an internal structure of the vehicle-following deceleration control system is divided into different functional modules to complete the above-described all or a part of functions. Herein, each functional module may be implemented in a hardware form and may also be implemented in a software functional module.

Those skilled in the art may understand that, all or a part of procedures in the method for implementing the above embodiment may be completed by enabling a computer program to direct relevant hardware. The program may be stored in a computer readable storage medium to be sold or used as an independent product. When the program is run, all or a part of steps in the embodiment of the method may be performed. The storage medium may be a magnetic disk, an optical disk, a read-only memory (ROM), or a random access memory (RAM), etc.

In the above embodiments, the description on each embodiment has its preference. The portion not detailed in some embodiment may be referred to relevant description in other embodiments.

The foregoing description only describes several implementation manners of the present disclosure, but is not intended to limit the protection scope of the present disclosure. It is to be noted that, any variation or replacement made by those of ordinary skill in the art without departing from the concept of the present disclosure shall fall within the protection scope of the present disclosure. Therefore, the protection scope of the present disclosure shall be subject to the claims.

What is claimed is:

1. A vehicle-following deceleration control method, comprising:
acquiring a current deceleration of a front vehicle and a current inter-vehicle time distance between a current vehicle and the front vehicle, and monitoring whether a brake lamp of the front vehicle lights or not;
when monitoring that the brake lamp of the front vehicle lights, performing increase correction on an absolute value of the current deceleration of the front vehicle to obtain a deceleration corrected value, and/or performing an increase correction on a preset inter-vehicle time distance threshold of an Adaptive Cruise Control (ACC) system of the current vehicle to obtain an inter-vehicle time distance threshold corrected value: and
sending a deceleration request by the ACC system of the current vehicle, in a case where an absolute value of the deceleration corrected value is greater than or equal to an absolute value of a preset deceleration threshold of the ACC system of the current vehicle, or the current inter-vehicle time distance between the current vehicle and the front vehicle is smaller than or equal to the inter-vehicle time distance threshold corrected value.

2. The vehicle-following deceleration control method as claimed in claim 1, wherein monitoring whether a brake lamp of the front vehicle lights or not comprises:
collecting an image of the front vehicle in a lane which the current vehicle is in, recognizing an area where the brake lamp of the front vehicle is located from the image, and judging whether the brake lamp of the front vehicle lights or not according to an image of the area where the brake lamp of the front vehicle is located;
wherein the brake lamp of the front vehicle comprises one or more of a left brake lamp, a right brake lamp and a high brake lamp of the front vehicle.

3. The vehicle-following deceleration control method as claimed in claim 1, wherein
performing increase correction on an absolute value of a current deceleration of the front vehicle comprises: replacing the absolute value of the current deceleration of the front vehicle as a first set value, the first set value being greater than the absolute value of the current deceleration of the front vehicle; or magnifying the absolute value of the current deceleration of the front vehicle by a first set times; and/or
performing increase correction on a preset inter-vehicle time distance threshold of an ACC system of the current vehicle comprises: replacing the preset inter-vehicle time distance threshold of the ACC system of the current vehicle as a second set value, the second set value being greater than the preset inter-vehicle time distance threshold; or magnifying the preset inter-vehicle time distance threshold of the ACC system of the current vehicle by a second set times.

4. The vehicle-following deceleration control method as claimed in claim 1 wherein
sending a deceleration request by the ACC system of the current vehicle, in a case where an absolute value of the deceleration corrected value is greater than or equal to an absolute value of a preset deceleration threshold of the ACC system of the current vehicle, comprises: sending, by the ACC system of the current vehicle, the deceleration corrected value to a brake execution mechanism, in a case where the absolute value of the deceleration corrected value is greater than or equal to the absolute value of the preset deceleration threshold of the ACC system of the current vehicle;
after sending, by the ACC system of the current vehicle, the deceleration corrected value to the brake execution mechanism, the method further comprises: acquiring a deceleration request value, generated by the ACC system of the current vehicle according to a current working condition, according to a set time period, and comparing an absolute value of the deceleration request value with the absolute value of the deceleration corrected value, wherein the deceleration request value is a deceleration generated by the ACC system of the current vehicle under the current working condition according to an uncorrected deceleration of the front vehicle; and continuously sending, by the ACC system of the current vehicle, the deceleration corrected value to the brake execution mechanism, in a case where the absolute value of the deceleration request value is smaller than the absolute value of the deceleration corrected value, or otherwise, sending, by the ACC system of the current vehicle, the deceleration request value to the brake execution mechanism.

5. The vehicle-following deceleration control method as claimed in claim 1, wherein
sending a brake request by the ACC system of the current vehicle, in a case where the current inter-vehicle time distance between the current vehicle and the front vehicle is smaller than or equal to the inter-vehicle time distance threshold corrected value comprises: sending a brake request to the brake execution mechanism by the ACC system of the current vehicle according to the inter-vehicle time distance threshold corrected value, in a case where the current inter-vehicle time distance between the current vehicle and the front vehicle is smaller than or equal to the inter-vehicle time distance threshold corrected value;
after sending the brake request to the brake execution mechanism by the ACC system of the current vehicle according to the inter-vehicle time distance threshold corrected value, the method further comprises: periodically judging whether the current vehicle is in a deceleration working condition or not at present, wherein the deceleration working condition refers to that the brake lamp of the front vehicle lights and a deceleration request value generated by the ACC system of the current vehicle under the current working condition according to an uncorrected deceleration of the front vehicle is smaller than 0; and continuously sending, by the ACC system of the current vehicle, a brake request to the brake execution mechanism according to the inter-vehicle time distance threshold corrected value, in a case where the current vehicle is in the deceleration working condition, or otherwise, sending, by the ACC system of the current vehicle, a brake request to the brake execution mechanism according to an uncorrected inter-vehicle time distance threshold.

6. A vehicle-following deceleration control system, comprising:
a monitoring module, configured to acquire a current deceleration of a front vehicle and an current inter-vehicle time distance between a current vehicle and the front vehicle, and monitor whether a brake lamp of the front vehicle lights or not;
a correction module, configured to, when it is monitored that the brake lamp of the front vehicle lights; perform increase, correction on an absolute value of the current deceleration of the front vehicle to obtain a deceleration corrected value, and/or perform an increase correction, on a preset inter-vehicle time distance threshold of an Adaptive Cruise Control (ACC) system of the current vehicle to obtain an inter-vehicle time distance threshold corrected value; and
a deceleration response module, configured to send a deceleration request via the ACC system of the current vehicle, in a case where an absolute value of the deceleration corrected value is greater than or equal to an absolute value of a preset deceleration threshold of the ACC system of the current vehicle, or in a case where the current inter-vehicle time distance between the current vehicle and the front vehicle is smaller than or equal to the inter-vehicle time distance threshold corrected value.

7. The vehicle-following deceleration control system as claimed in claim 6, wherein the monitoring module comprises:
a vehicle lamp monitoring unit, configured to collect an image of the front vehicle in a lane which the current vehicle is in, recognize an area where a brake lamp of the front vehicle is located from the image, and judge whether the brake lamp of the front vehicle lights or not according to an image of the area where the brake lamp of the front vehicle is located.

8. The vehicle-following deceleration control system as claimed in claim 6, wherein the correction module comprises:
a first correction unit, configured to replace the absolute value of the current deceleration of the front vehicle as a first set value, the first set value being greater than the absolute value of the current deceleration of the front vehicle, or magnify the absolute value of the current deceleration of the front vehicle by a first set times;
a second correction unit, configured to replace the preset inter-vehicle time distance threshold of the ACC system of the current vehicle as a second set value, the second set value being greater than the inter-vehicle time distance threshold, or magnify the preset inter-vehicle time distance threshold of the ACC system of the current vehicle by a second set times.

9. The vehicle-following deceleration control system as claimed in claim 6, wherein
the deceleration response module comprises: a first deceleration response unit, configured to send the deceleration corrected value to a brake execution mechanism via the ACC system of the current vehicle, in a case where the absolute value of the deceleration corrected value is greater than or equal to the absolute value of the preset deceleration threshold of the ACC system of the current vehicle;
the deceleration response module further comprises: a comparison unit, configured to acquire a deceleration request value, generated by the ACC system of the current vehicle according to a current working condition, according to a set time period, and compare an absolute value of the deceleration request value with the absolute value of the deceleration corrected value, wherein the deceleration request value is a deceleration generated by the ACC system of the current vehicle under the current working condition according to an uncorrected deceleration of the front vehicle; and a first switching unit, configured to notify the first deceleration response unit of continuously sending the deceleration corrected value to the brake execution mechanism, in a case where the absolute value of the deceleration request value is smaller than the absolute value of the deceleration corrected value, or otherwise, notify the first deceleration response unit of sending the deceleration request value to the brake execution mechanism via the ACC system of the current vehicle.

10. The vehicle-following deceleration control system as claimed in claim 6, wherein the deceleration response module comprises:
a second deceleration response unit, configured to send a brake request to the brake execution mechanism via the ACC system of the current vehicle according to the inter-vehicle time distance threshold corrected value, in a case where the current inter-vehicle time distance between the current vehicle and the front vehicle is smaller than or equal to the inter-vehicle time distance threshold corrected value;
a working condition detection unit, configured to periodically judge whether the current vehicle is in a deceleration working condition or not at present, after sending the brake request to the brake execution mechanism via the ACC system of the current vehicle according to the inter-vehicle time distance threshold corrected value, wherein the deceleration working condition refers to that the brake lamp of the front vehicle lights and a deceleration request value generated by the ACC system of the current vehicle under the current working condition according to an uncorrected deceleration of the front vehicle is smaller than 0; and
a second switching unit, configured to notify the second deceleration response unit of continuously sending the brake request to the brake execution mechanism according to the inter-vehicle time distance threshold corrected value, in a case where it is judged that a detection result of the working condition detection unit is that the current vehicle is in the deceleration working, condition, or otherwise, notify the second deceleration response unit of sending the brake request to the brake execution mechanism via the ACC system of the current vehicle according to an uncorrected inter-vehicle time distance threshold.
